(19) United States
(12) Patent Application Publication
(10) Pub. No.: US 2026/0350754 A1
(43) Pub. Date: Nov. 5, 2026

(54) SYSTEM AND METHOD FOR ENHANCING OPTICAL COHERENCE TOMOGRAPHY DESPECKLING WITHOUT CLEAN DATA

(71) Applicant: UNIVERSITY OF PITTSBURGH - OF THE COMMONWEALTH SYSTEM OF HIGHER EDUCATION, PITTSBURGH, PA (US)

(72) Inventors: Lingyun Wang, Pittsburgh, PA (US); Shaohua Pi, Wexford, PA (US)

(73) Assignee: UNIVERSITY OF PITTSBURGH - OF THE COMMONWEALTH SYSTEM OF HIGHER EDUCATION, PITTSBURGH, PA (US)

(21) Appl. No.: 19/629,241

(22) Filed: Mar. 26, 2026

Related U.S. Application Data
(60) Provisional application No. 63/789,594, filed on Apr. 16, 2025.

(51) Int. Cl. G06T 5/60; G06T 12/30

(52) U.S. Cl. CPC G06T 5/60; G06T 12/30; G06T 2207/10101

(57) ABSTRACT

An OCT denoising solution utilizes a trained neural network to generate despeckled OCT images from captured noisy OCT images. The neural network is trained in multiple training epochs wherein each training epoch uses repeated (first and second) full spectrum B-scan images. In each epoch, a number sub-band B-scan images generated from the first repeated full spectrum B-scan image are used as the input to the neural network, while the second repeated full spectrum B-scan image is set as the target for the neural network. In short, the solution works by generating a low-resolution (LR) image for expanded mapping to multiple underlaying high-resolution (HR) images, and thus increases the possibility to converge to the true clean image.

### CROSS REFERENCE TO RELATED APPLICATIONS

This application claims priority to U.S. Provisional Patent Application Ser. No. 63/789,594, filed on Apr. 16, 2025 and titled “System and Method for Enhancing Optical Coherence Tomography Despeckling Without Clean Data,” the disclosure of which is incorporated herein by reference.

### FIELD OF THE INVENTION

The disclosed concept relates generally to Optical Coherence Tomography (OCT), and, in particular, to a system and method for generating OCT images with reduced speckle noise that does not require the use of noise free, clean data.

### BACKGROUND OF THE INVENTION

OCT is a scattering-based, depth-resolved, micron-resolution imaging technique that has become a routine imaging modality in ophthalmology. However, speckle noise, which is induced by the interference of scattered light, obscures the implementation of ideal axial resolution, bringing challenges to the subsequent image analysis and interpretation.

Conventional OCT denoising approaches typically rely on sparse reconstruction or frame averaging. The major drawback of sparse reconstruction methods is the potential blurring of images, limiting the visualization of fine structures. Frame averaging schemes are subject to long acquisition times (especially for volume averaging) and precise image registration, making them susceptible to eye movements and less practical in clinical applications.

Recently, with the rapid development of deep learning, various neural networks, including those that employ both supervised and self-/unsupervised strategies, have been proposed for OCT despeckling. For instance, Y. Ma, X. Chen, W. Zhu et al., Biomedical optics express 9, 5129-5146 (2018) describes a supervised cGAN method that relies on frame-merged noise-free images for training. Although effective, the supervised methods pose the challenge of obtaining noise-free images (which is also required in the frame averaging method described above). Certain known self-/unsupervised methods can address this problem, requiring only noisy images. For example, J. Lehtinen, J. Munkberg, J. Hasselgren et al., “Noise2noise: Learning image restoration without clean data,” presented at the Proceedings of the 35th International Conference on Machine Learning, Proceedings of Machine Learning Research (2018), provides an approach referred to as Noise2Noise (N2N), to restore the images by using two independent observations of the same scene to estimate the real structure. Additionally, so called blind-spot schemes, such as the scheme described in A. Krull, T.-O. Buchholz, and F. Jug, “Noise2void-learning denoising from single noisy images,” in Proceedings of the IEEE/CVF conference on computer vision and pattern recognition (2019), pp. 2129-2137, and referred to as Noise2Void (N2V), use only one observation per scene by strategically masking the central pixel of a patch during training, treating the masked central pixel as the target for the network. However, the performance of N2V is usually less optimal as compared the performance of N2N since gradient information is backpropagated only for the masked pixels. In addition, the translation of N2V for OCT does not bring any advantage as OCT routinely acquires at least two repeated B-scans for applications like OCT angiography.

Visible light OCT (vis-OCT) is an emerging modality with higher scattering contrast and improved axial resolution than standard near-infrared OCT (NIR-OCT). These benefits enable the visualization of retinal fine structures in the inner plexiform layer and outer retinal bands. However, the strong speckle noise undermines these advantages, making frame averaging an essential procedure in visualizing these fine structures.

Therefore, there is a need for an advanced despeckling method for OCT, including, without limitations, vis-OCT or traditional OCT that uses near-infrared light.

### SUMMARY OF THE INVENTION

In one embodiment, a method of training a neural network for generating OCT images with reduced speckle noise is provided. The method includes: (i) creating a training data set including a plurality of data groups from a number of objects by performing the following steps for each object and each of a plurality of locations within the object: acquiring a first full spectrum (HR) B-scan image at the location and a second full spectrum (HR) B-scan at the location; and generating a number of sub-band (LR) B-scan images from the first full spectrum (HR) B-scan image, wherein the number of sub-band (LR) B-scan images and the second full spectrum (HR) B-scan image together form one of the data groups; and (ii) for each of the data groups of the training data set, performing the following: providing the data group as inputs into the neural network with a target of the neural network being set as the second full spectrum (HR) B-scan image of the data group to produce a predicted neural network output; calculating a loss value by quantifying a difference between the predicted neural network output and the second full spectrum (HR) B-scan image of the data group; and optimizing one or more parameters of the neural network based on the calculated loss value.

In another embodiment, a method of generating an OCT image with reduced speckle noise is provided that includes capturing a full spectrum (HR) B-scan image of an object, generating a sub-band (LR) B-scan image from the captured full spectrum (HR) B-scan image, and providing the sub-band (LR) B-scan image to a trained neural network configured to generate reduced speckle noise OCT images from provided sub-band (LR) B-scan images, wherein the trained neural network has been previously trained using the training method described above.

In still another embodiment, a system of generating an OCT image with reduced speckle noise is provided that includes a processing apparatus implementing a trained neural network configured to generate reduced speckle noise OCT images from provided sub-band (LR) B-scan images, wherein the processing apparatus is structured and configured to receive a sub-band (LR) B-scan generated from a full spectrum (HR) B-scan image and provide the sub-band (LR) B-scan to the trained neural network, and wherein the trained neural network has been previously trained using the method described above.

### BRIEF DESCRIPTION OF THE DRAWINGS

A full understanding of the invention can be gained from the following description of the preferred embodiments when read in conjunction with the accompanying drawings in which:

FIG. 1 illustrates that in OCT image processing, when the resolution of the input OCT image R1 and the target OCT image R2 are similar, the gradient tends to point to the target with a 1:1 mapping, while a single observation of the object cannot encapsulate the real scene (real target);

FIG. 2 illustrates a framework for training a neural network according to an embodiment of the disclosed concept;

FIG. 3A is a flowchart showing a method of creating a training data set for training a neural network in multiple training epochs according to an exemplary embodiment of the disclosed concept;

FIG. 3B shows the steps that are performed for each of the training epochs of the training method according to an exemplary embodiment of the disclosed concept;

FIG. 4 shows the configuration of a U-Net architecture that may be used to implement the trained neural network of the disclosed concept according to an exemplary embodiment; and

FIG. 5 is a schematic diagram of an exemplary OCT system for ophthalmologic applications in which the trained neural network according to the disclosed concept may be implemented.

### DETAILED DESCRIPTION

As used herein, the singular form of “a”, “an”, and “the” include plural references unless the context clearly dictates otherwise.

As used herein, the term “number” shall mean one or an integer greater than one (i.e., a plurality).

As used herein, the terms “component” and “system” are intended to refer to a computer related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers. While certain ways of displaying information to users are shown and described with respect to certain figures or graphs, those skilled in the relevant art will recognize that various other alternatives can be employed.

As used herein, the term “low-resolution (LR) image” refers to a digital image with limited axial resolution, generated from a narrow spectral bandwidth. Such images contain fewer distinguishable details and poorer axial differentiation of structures, resulting in reduced clarity and precision in depicting fine features and textures.

As used herein, the term “high-resolution (HR) image” refers to a digital image characterized by high axial resolution, typically produced using a wide spectral bandwidth. Such images offer enhanced differentiation of structures along the axial direction, enabling precise depiction of fine anatomical details, textures, and features.

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

The disclosed concept will now be described, for purposes of explanation, in connection with numerous specific details in order to provide a thorough understanding of the disclosed concept. It will be evident, however, that the disclosed concept can be practiced without these specific details without departing from the spirit and scope of this innovation.

Recognizing the need for a more effective and robust OCT denoising solution without clean data, the disclosed concept provides an innovative strategy, referred to as Sub2Full (S2F), that utilizes a trained neural network to generate despeckled OCT images from captured noisy OCT images. As described in greater detail herein, the neural network is trained in multiple training epochs wherein each training epoch uses repeated (first and second) B-scan images. In each epoch, a number sub-band B-scan images generated from the first repeated full spectrum B-scan image are used as the input to the neural network, while the second repeated full spectrum B-scan image is set as the target for the neural network. In short, the strategy of the disclosed concept works by generating a low-resolution (LR) image for expanded mapping to multiple underlaying high-resolution (HR) images, and thus increases the possibility to converge to the true clean image. Once the neural network has been trained as described herein, it may then be used to generate OCT images with reduced speckled noises (i.e., despeckled) from noisy OCT images that are captured from a subject.

As described herein, the S2F strategy of the disclosed concept has been shown to achieve superior performance over the N2N and N2V schemes described elsewhere herein, by identifying the sublaminar structure of the outer retina in a single B-scan frame without averaged clean data in vis-OCT. Although validated in vis-OCT, it should be noted that the S2F strategy of the disclosed concept may be applied to all OCT types for improved denoising performance.

To delve into the principles of the S2F scheme of the disclosed concept, it is important to first understand the mechanism of traditional supervised/unsupervised deep learning denoising methods. Due to the speckle noise, a B-scan image in OCT can be expressed by y₁=x+n₁, where clean image x is corrupted by a zero-mean independent speckle noise n₁. Therefore, the endeavor of a supervised denoising method is to minimize the discrepancy between the noisy input y₁ and the corresponding clean target x through the equation below:

$$\text{?} [ {‖ {f}_{θ} ( {y}_{1} ) - x ‖}_{2}^{2} ] = \text{?} [ {‖ {f}_{θ} ( {y}_{1} ) ‖}_{2}^{2} - 2 {x}^{T} {f}_{θ} ( {y}_{1} ) + {‖ x ‖}_{2}^{2} ] ,$$

where

$${‖ \cdot ‖}_{2}^{2}$$

denotes the L2 norm, θ is the trainable parameters of a neural network f, and [symbol] denotes the expectation. Since

$$\text{?} [ {‖ x ‖}_{2}^{2} ]$$

is a constant, is a constant, the network training process involves searching for an optimal solution for θ using the equation below:

$$arg min \text{?} [ {‖ {f}_{θ} ( {y}_{1} ) ‖}_{2}^{2} - 2 {x}^{T} {f}_{θ} ( {y}_{1} ) ] .$$

For the prior art N2N method, there are two repeated scans acquired from the object, and the second repeated image can be expressed as y₂=x+n₂. Therefore, the two independent observations (B-scan images) serve as a noisy input and a corresponding noisy target, respectively:

$$\begin{matrix}\text{?} [ {‖ {f}_{θ} ( {y}_{1} ) - {y}_{2} ‖}_{2}^{2} ] = \text{?} [ {‖ {f}_{θ} ( {y}_{1} ) - x - {n}_{2} ‖}_{2}^{2} ] \\ = \text{?} [ {‖ {f}_{θ} ( {y}_{1} ) - x ‖}_{2}^{2} + {‖ {n}_{2} ‖}_{2}^{2} - \\ 2 {n}_{2}^{T} ( {f}_{θ} ( {y}_{1} ) - x ) ] \\ = \text{?} [ {‖ {f}_{θ} ( {y}_{1} ) ‖}_{2}^{2} - 2 {x}^{T} {f}_{θ} ( {y}_{1} ) + {‖ x ‖}_{2}^{2} + {‖ {n}_{2} ‖}_{2}^{2} + \\ 2 {n}_{2}^{T} x ] - 2 \text{?} [ {n}_{2}^{T} ] \text{?} [ ‖ {f}_{θ} ( {y}_{1} ) ] ,\end{matrix} ,$$

where

$$\text{?} [ {‖ x ‖}_{2}^{2} ] + {‖ {n}_{2} ‖}_{2}^{2} + 2 {n}_{2}^{T} x ]$$

is a constant scalar and

$$\text{?} [ {n}_{2}^{T} ]$$

is zero as the Horse is zero-mean. Hence, the optimization solution for θ in the N2N method is determined by

$$arg min \text{?} [ {‖ {f}_{θ} ( {y}_{1} ) ‖}_{2}^{2} - 2 {x}^{T} {f}_{θ} ( {y}_{1} ) ] ,$$

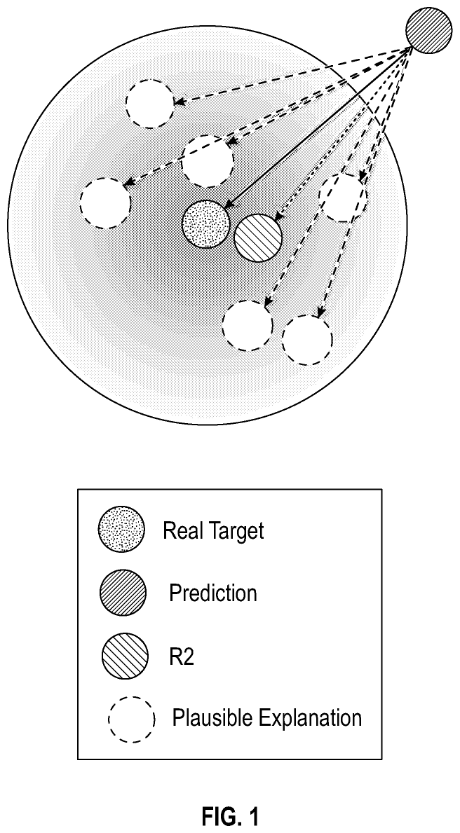

similar to the supervised method with a clean image. As long as the noise is zero-mean and independent, optimization of the N2N method can converge to the same solution as supervised training even if the noise distribution in two observations changes. However, the N2N method cannot achieve results comparable to supervised methods unless it is trained on an infinitely large dataset. As illustrated in FIG. 1, when the resolution of the input OCT image R1 and the target OCT image R2 are similar, the gradient tends to point to the target with a 1:1 mapping, while a single observation of the object cannot encapsulate the real scene (real target).

Turning now to the disclosed concept, the S2F strategy of the disclosed concept trains a neural network, such as a convolutional neural network (customized U-Net in the exemplary embodiment), in multiple training epoch as described below, wherein each training epoch uses repeated (first and second) HR B-scan images R1 and R2. More specifically, in each epoch, LR images obtained by splitting the spectrum of the HR B-scan image R1 are used as inputs to the neural network, while the HR B-scan image R2 is used as the target. Using the LR images obtained as described means that multiple plausible HR images will exist. As shown in FIG. 1, the 1:N mapping will force the gradient to propagate in the direction of each plausible explanation (denoted by dashed arrows), ultimately achieving the improved optimization of pointing to the real target. Once the neural network has been trained as described herein, it can create despeckled OCT images from captured OCT images based on sub-band (LR) B-scan images obtained from the captured OCT images (the sub-band (LR) B-scan images are fed into the trained neural network and the despeckled OCT images are output from the trained neural network).

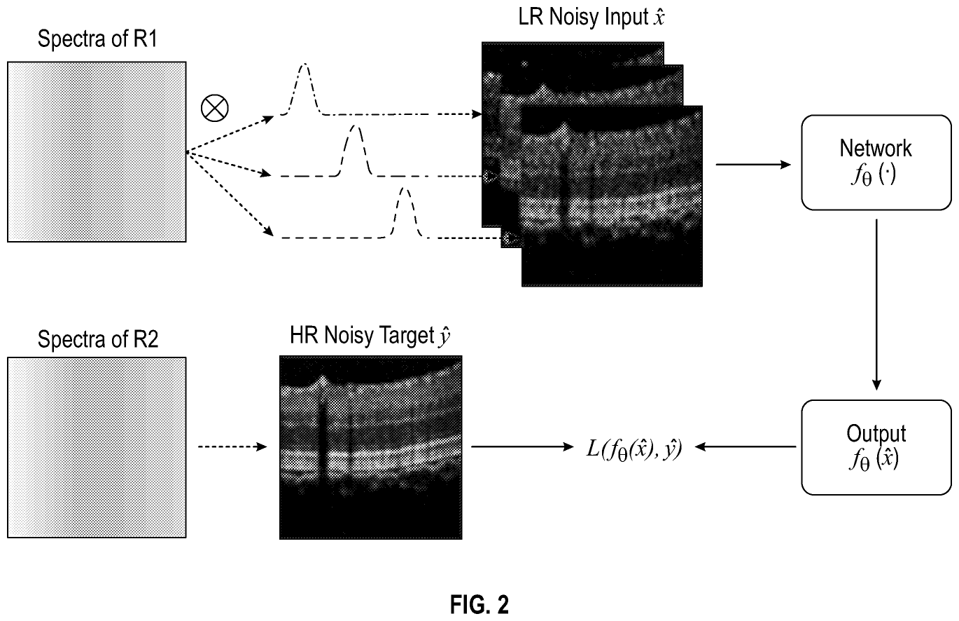

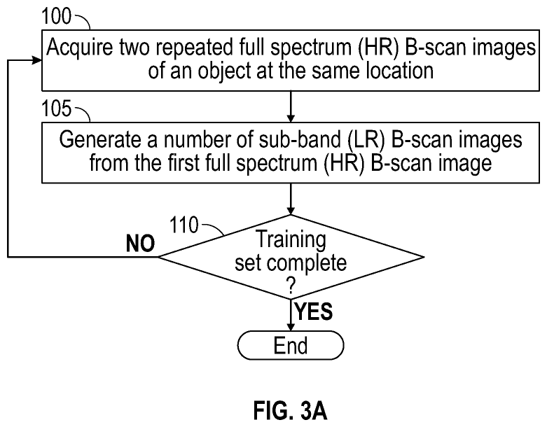

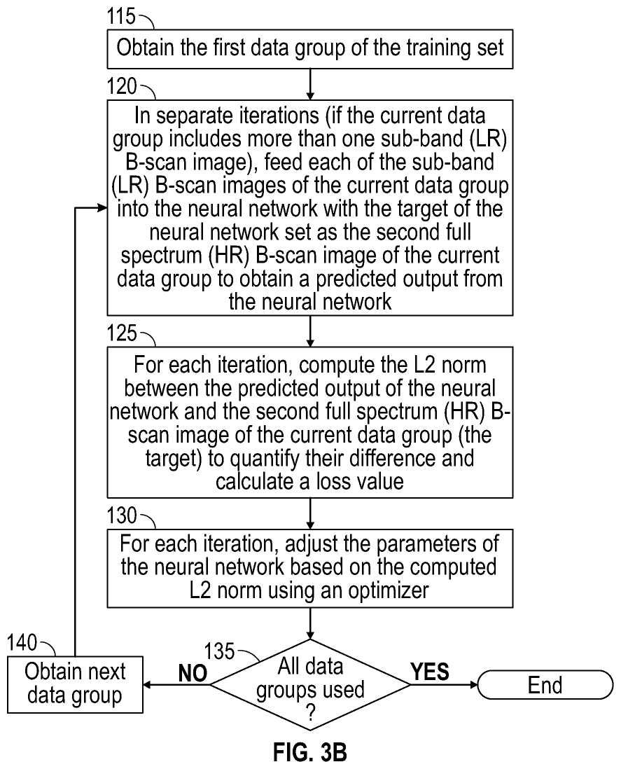

The framework for training the neural network of the S2F strategy of the disclosed concept is summarized in FIG. 2 and is described below in connection with the flowcharts shown in FIGS. 3A and 3B. More specifically, FIG. 3A is a flowchart showing a method of creating a training data set for training the neural network of the S2F strategy according to the exemplary embodiment. As noted above, the neural network of the disclosed concept is trained in multiple training epochs using the training data set created using the method of FIG. 3A. FIG. 3B shows the steps that are performed for each of the training epochs.

As seen in FIG. 3A, method begins at step 100, wherein two repeated full spectrum (HR) B-scan images of an object are acquired at the same location of the object. Next, at step 105, a number of sub-band (LR) B-scan images are generated from the first full spectrum (HR) B-scan image. In the exemplary embodiment, each of the sub-band (LR) B-scan images is generated at the A-scan level of the first full spectrum (HR) B-scan image. By way of additional background, in OCT, an A-scan refers to a one-dimensional depth profile, and each A-scan represents the reflectivity information along the axial (depth) direction at a specific lateral position. A B-scan is formed by compiling a sequence of adjacent A-scans, creating a two-dimensional cross-sectional image. Thus, in the exemplary embodiment, each of the sub-band (LR) B-scan images is generated by multiplying the spectrum of each individual A-scan of the first full spectrum (HR) B-scan image with a Gaussian window having a particular center position or bandwidth. This operation narrows the spectral bandwidth of each A-scan, thereby reducing its axial resolution. Applying this process to all A-scans within the first full spectrum (HR) B-scan image results in a lower-resolution B-scan image, which is referred to as the sub-band (LR) B-scan image. It should be noted that for each sub-band (LR) B-scan image, the configuration of Gaussian window should be consistent across all A-scans of the first full spectrum (HR) B-scan image. In step 105, multiple sub-band (LR) B-scan images may be generated, with each one being generated using a Gaussian window having a different center position or bandwidth. In other words, by changing the center position or bandwidth of the Gaussian window, the disclosed concept is able to obtain several sub-band (LR) B-scan images from the full spectrum (HR) B-scan image. Using multiple sub-band (LR) B-scan images in step 105 provides the neural network with different spatial perspectives and allows the neural network to access a boarder range of information for improved and more robust performance on unseen data. In the non-limiting exemplary embodiment, 3 such sub-band (LR) B-scan images are generated at step 105, each one using a Gaussian window having a different center position or bandwidth.

Next, at step 110, determination is made as to whether the training data set is complete. If the answer is YES, then the method ends. If the answer is NO, then the method returns to steps 100 and 105, wherein two new repeated full spectrum (HR) B-scan images of an object are acquired at the same location of the object and the associated sub-band (LR) B-scan images are created. In the exemplary embodiment, steps 100 and 105 are repeated a predetermined number of times (for example 400 times) when creating the training data set. Steps 100 and 105 can be performed on the same eye (same patient) and/or different eyes (different patients) to ensure diversity in the dataset. If repeated on the same eye, the B-scans are typically acquired at different lateral locations to capture varied structural details within the same eye. Additionally, including different eyes from multiple patients further enhances the generalizability and robustness of the model.

Thus, at the end of the method of FIG. 3A, the training data set will include a predetermined number (400 in the example above) of associated data groups, one for each pass through the method of FIG. 3A, where each data group includes: (i) the second full spectrum (HR) B-scan image captured during the pass through the method of FIG. 3A, and (ii) the associated sub-band (LR) B-scan image(s) (3 such images using the example above) generated from the first full spectrum (HR) B-scan image captured during the pass through the method of FIG. 3A. In other words, in the example above, each of the 400 data groups of the training data set will include 400 different second B-scan images and 1,200 different sub-band B-scan images, associated in groups of three with the second B-scan images.

As noted above, once the training data set is created, it may then be used to train the neural network in one or more training epochs. The method used in each training epoch is shown in FIG. 3B. In the exemplary embodiment, each training epoch consists of multiple iterations, where in each iteration the neural network generates a predicted output based on the input, and the neural network parameter(s) are updated using an optimizer based on the loss value calculated between the predicted output and the target. Training is performed for a predetermined number of training epochs or until certain predetermined convergence criteria are satisfied, whichever comes earlier. The predetermined convergence criteria may be, for example and without limitation, that the mean of the calculated loss value within an epoch does not decrease over 30 consecutive epochs. The parameters from the training epoch where the mean loss value of all iterations is lowest will be saved.

Referring to FIG. 3B, the method begins at step 115, wherein the first data group from the training set is obtained. Next, at step 120, each of the sub-band (LR) B-scan images of the current data group (generated at step 105) is fed, in separate iterations if more than one sub-band (LR) B-scan image is used, into the neural network with the target of the neural network being set as the second full spectrum (HR) B-scan image of the current data group. Each iteration will result in a predicted output being generated from the neural network. Thus, at step 125, for each iteration the L2 norm (i.e. Euclidean norm) between the predicted output of the neural network and the second full spectrum (HR) B-scan image (the target) of the current data group is computed to quantify the difference between them. In this aspect, the L2 norm is used as the loss function for the training. At step 130, for each iteration the parameters of the neural network are adjusted based on the computed L2 norm using an optimizer, which in the non-limiting exemplary embodiment is the Adam optimizer. The use of the optimizer in step 130 minimizes loss value during the training. At step 135, a determination is made as to whether all of the data groups of the training data set have been used. If the answer is no, then the method proceeds to step 140, where the next data group is obtained and the method returns to step 130 for further processing using that next data group. If, however, the answer at step 135 is yes, then the method ends and the training epoch is completed.

In the disclosed concept, as noted above, the process of FIG. 3B is repeated across multiple training epochs to the train the neutral network so that it may ultimately be used to generate despeckled OCT images from captured noisy OCT images. For example, in one non-limiting exemplary embodiment implemented by the present inventors, the neural network was trained using 200 training epochs to ensure convergence using a training dataset containing 400 data groups (i.e., 400 targets and their corresponding 1,200 sub-band (LR) B-scan images).

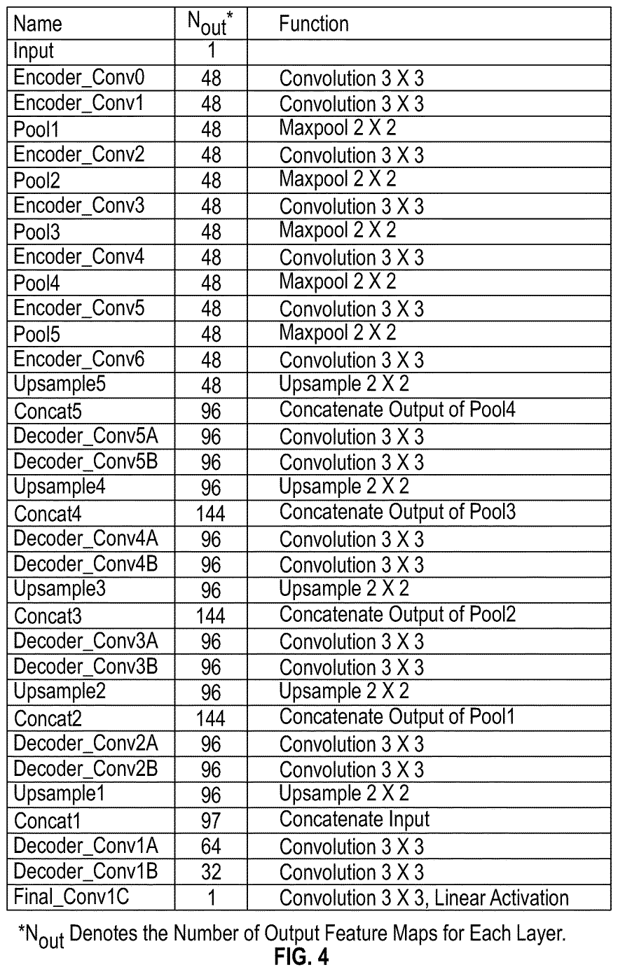

As noted elsewhere herein, in one non-limiting exemplary embodiment, the neural network of the disclosed concept a convolutional neural network in the form of a customized U-Net architecture. It will be understood, however, that other types of neural networks, such as, without limitation, a transformer-based neural network, or another deep learning architecture suitable for image processing tasks, may also be used within the scope of the disclosed concept. The U-Net architecture is commonly used for image segmentation and includes an encoder-decoder structure with skip connections, allowing it to capture both fine-grained details and broader contextual information. In the non-limiting exemplary embodiment, the configuration of the U-Net architecture is shown in FIG. 4.

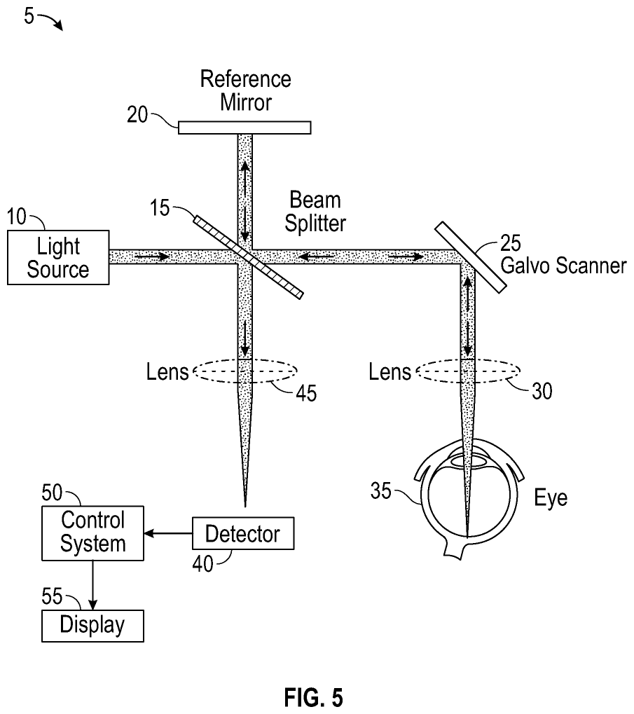

FIG. 5 is a schematic diagram of an exemplary OCT system 5 for ophthalmologic applications in which the trained neural network according to the disclosed concept may be implemented. It will be understood, however, that OCT system 5 is meant to be exemplary only, and that the trained neural network of the disclosed concept may be implemented in other types of OCT systems. OCT system 5 includes a light source 10, which in the exemplary embodiment may be a visible light source or near-infrared light source, a beam splitter 15, a reference mirror 20, a galvo scanner 25, a lens 30 for focusing light from galvo scanner 25 onto an eye 35, a detector 40 (a photodetector), lens 45 for focusing light from beam splitter 15 onto detector 40, a control system 50, and a display 55. In OCT system 5, beam splitter 15 is structured to direct the light from light source 10 to reference mirror 20, which reflects a reference light signal back to detector 40 through beam splitter 15 and lens 45. In addition, beam splitter 15 also directs a portion of the light from the light source 10 to galvo scanner 25 and ultimately to the eye 35 that is being examined through lens 30. Light that is reflected from eye 35 is directed by lens 30, galvo scanner 25, beam splitter 15 and lens 45 to detector 40. The light signals detected by detector 40 are provided to control system 50 for signal processing and other analysis. Control system 50 generates number of OCT images that may be displayed on display 55.

Control system 50 is a computing device structured and configured to control galvo scanner 25 and process the signals from detector to generate despeckled OCT images using the trained neural network as described herein. Control system 50 may be, for example and without limitation, a PC, a laptop computer, or any other suitable device structured to perform the functionality described herein. Control system 50 a processing apparatus comprising a processor and a memory. The processor may be, for example and without limitation, a microprocessor (μP), a microcontroller, or some other suitable processing device, that interfaces with the memory. The memory can be any one or more of a variety of types of internal and/or external storage media such as, without limitation, RAM, ROM, EPROM(s), EEPROM(s), FLASH, and the like that provide a storage register, i.e., a non-transitory machine readable medium, for data storage such as in the fashion of an internal storage area of a computer, and can be volatile memory or nonvolatile memory. The memory has stored therein a number of routines (comprising computer executable instructions) that are executable by the processor, including routines for implementing the disclosed concept as described herein. In particular, processing apparatus includes neural network component for generating despeckled OCT images from captured noisy OCT images that implements the S2F strategy as described herein. OCT system 5 is thus able to provide enhanced imaging for the user (e.g., a healthcare provider), as it is able to generate images with reduced speckle noise.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A method of training a neural network for generating OCT images with reduced speckle noise, comprising:
(i) creating a training data set including a plurality of data groups from a number of objects by performing the following steps for each object and each of a plurality of locations within the object:
acquiring a first full spectrum (HR) B-scan image at the location and a second full spectrum (HR) B-scan at the location; and
generating a number of sub-band (LR) B-scan images from the first full spectrum (HR) B-scan image, wherein the number of sub-band (LR) B-scan images and the second full spectrum (HR) B-scan image together form one of the data groups; and
(ii) for each of the data groups of the training data set, performing the following:
providing the data group as inputs into the neural network with a target of the neural network being set as the second full spectrum (HR) B-scan image of the data group to produce a predicted neural network output;
calculating a loss value by quantifying a difference between the predicted neural network output and the second full spectrum (HR) B-scan image of the data group; and
optimizing one or more parameters of the neural network based on the calculated loss value.

2. The method according to claim 1, wherein the generating the number of sub-band (LR) B-scan images from the first full spectrum (HR) B-scan image is performed using A-scans of the first full spectrum (HR) B-scan image.

3. The method according to claim 2, wherein each of the number of sub-band (LR) B-scan images is generated by multiplying the spectrum of each individual A-scan of the first full spectrum (HR) B-scan image with a Gaussian window having a particular center position or bandwidth.

4. The method according to claim 3, wherein the number of sub-band (LR) B-scan images is a plurality of sub-band (LR) B-scan images, wherein each of the plurality of sub-band (LR) B-scan images is generated with a different Gaussian window having a different particular center position or bandwidth that is unique to the sub-band (LR) B-scan image.

5. The method according to claim 3, wherein the number of sub-band (LR) B-scan images is a plurality of sub-band (LR) B-scan images and wherein the plurality of sub-band (LR) B-scan images are input into the neural network in separate iterations.

6. The method according to claim 1, wherein the calculating the loss value includes computing the L2 norm between the predicted neural network output and the second full spectrum (HR) B-scan image, and wherein the optimizing comprises adjusting the one or more parameters of the neural network based on the L2 norm.

7. The method according to claim 1, wherein the optimizing comprises optimizing the one or more parameters of the neural network based on the calculated loss value using an optimizer.

8. The method according to claim 7, wherein the optimizer is the Adam optimizer.

9. The method according to claim 1, wherein the neural network is a convolutional neural network, a transformer-based neural network, or another deep learning architecture suitable for image processing tasks.

10. The method according to claim 9, wherein the neural network is a convolutional neural network that comprises a U-net architecture.

11. The method according to claim 1, further comprising repeating the providing, calculating and optimizing steps a predetermined number of times or until predetermined convergence criterion or criteria are satisfied.

12. A method of generating an OCT image with reduced speckle noise, comprising:
capturing a full spectrum (HR) B-scan image of an object;
generating a sub-band (LR) B-scan image from the captured full spectrum (HR) B-scan image;
generating the OCT image with reduced speckle noise by providing the sub-band (LR) B-scan image to a trained neural network configured to generate reduced speckle noise OCT images from provided sub-band (LR) B-scan images, wherein the trained neural network has been created by training a neural network as follows:
(i) creating a training data set including a plurality of data groups from a number of objects by performing the following steps for each object and each of a plurality of locations within the object:
acquiring a first training full spectrum (HR) B-scan image at the location and a second training full spectrum (HR) B-scan at the location; and
generating a number of training sub-band (LR) B-scan images from the first training full spectrum (HR) B-scan image, wherein the number of training sub-band (LR) B-scan images and the second training full spectrum (HR) B-scan image together form one of the data groups; and
(ii) for each of the data groups of the training data set, performing the following:
providing the data group as inputs into the neural network with a target of the neural network being set as the second training full spectrum (HR) B-scan image of the data group to produce a predicted neural network output;
calculating a loss value by quantifying a difference between the predicted neural network output and the second training full spectrum (HR) B-scan image of the data group; and
optimizing one or more parameters of the neural network based on the calculated loss value.

13. The method according to claim 12, wherein the captured full spectrum (HR) B-scan image is a traditional visible light OCT image.

14. The method according to claim 12, wherein the full spectrum (HR) B-scan image comprises a number of individual A-scans each having a spectrum, and wherein the sub-band (LR) B-scan image is generated by multiplying the spectrum of each individual A-scan of the full spectrum (HR) B-scan image with a Gaussian window having a particular center position or bandwidth.

15. The method according to claim 12, wherein in (i) the generating the number of training sub-band (LR) B-scan images from the first training full spectrum (HR) B-scan image is performed using A-scans of the first training full spectrum (HR) B-scan image.

16. The method according to claim 15, wherein in (i) each of the number of training sub-band (LR) B-scan images is generated by multiplying the spectrum of each individual A-scan of the first training full spectrum (HR) B-scan image with a Gaussian window having a particular center position or bandwidth.

17. The method according to claim 16, wherein in (i) the number of training sub-band (LR) B-scan images is a plurality of training sub-band (LR) B-scan images, wherein each of the plurality of training sub-band (LR) B-scan images is generated with a different Gaussian window having a different particular center position or bandwidth that is unique to the training sub-band (LR) B-scan image.

18. The method according to claim 16, wherein in (i) the number of training sub-band (LR) B-scan images is a plurality of training sub-band (LR) B-scan images and wherein the plurality of training sub-band (LR) B-scan images are input into the neural network in separate iterations.

19. The method according to claim 12, wherein in (ii) the calculating the loss value includes computing the L2 norm between the predicted neural network output and the second training full spectrum (HR) B-scan image, and wherein the optimizing comprises adjusting the one or more parameters of the neural network based on the L2 norm.

20. The method according to claim 12, wherein in (ii) the optimizing comprises optimizing the one or more parameters of the neural network based on the calculated loss value using an optimizer.

21. The method according to claim 20, wherein the optimizer is the Adam optimizer.

22. The method according to claim 12, wherein the neural network is a convolutional neural network, a transformer-based neural network, or another deep learning architecture suitable for image processing tasks.

23. The method according to claim 22, wherein the neural network is a convolutional neural network that comprises a U-net architecture.

24. The method according to claim 12, further comprising in (ii) repeating the providing, calculating and optimizing steps a predetermined number of times or until predetermined convergence criterion or criteria are satisfied.

25. A system of generating an OCT image with reduced speckle noise, comprising:
a processing apparatus implementing a trained neural network configured to generate reduced speckle noise OCT images from provided sub-band (LR) B-scan images, wherein the processing apparatus is structured and configured to receive a sub-band (LR) B-scan generated from a full spectrum (HR) B-scan image, and provide the sub-band (LR) B-scan to the trained neural network for generation of the OCT image with reduced speckle noise, wherein the trained neural network has been created by training a neural network as follows:
(i) creating a training data set including a plurality of data groups from a number of objects by performing the following steps for each object and each of a plurality of locations within the object:
acquiring a first training full spectrum (HR) B-scan image at the location and a second training full spectrum (HR) B-scan at the location; and
generating a number of training sub-band (LR) B-scan images from the first training full spectrum (HR) B-scan image, wherein the number of training sub-band (LR) B-scan images and the second training full spectrum (HR) B-scan image together form one of the data groups; and
(ii) for each of the data groups of the training data set, performing the following:
providing the data group as inputs into the neural network with a target of the neural network being set as the second training full spectrum (HR) B-scan image of the data group to produce a predicted neural network output;
calculating a loss value by quantifying a difference between the predicted neural network output and the second training full spectrum (HR) B-scan image of the data group; and
optimizing one or more parameters of the neural network based on the calculated loss value.

26. The system according to claim 25, wherein the system is an OCT system that includes a light source and a detector for capturing OCT images.

27. The system according to claim 25, wherein the full spectrum (HR) B-scan image is a traditional visible light OCT image.

28. The system according to claim 27, wherein the full spectrum (HR) B-scan image comprises a number of individual A-scans each having a spectrum, and wherein the sub-band (LR) B-scan image is generated by multiplying the spectrum of each individual A-scan of the full spectrum (HR) B-scan image with a Gaussian window having a particular center position or bandwidth.

29. The system according to claim 25, wherein in (i) the generating the number of training sub-band (LR) B-scan images from the first training full spectrum (HR) B-scan image is performed using A-scans of the first training full spectrum (HR) B-scan image.

30. The system according to claim 29, wherein in (i) each of the number of training sub-band (LR) B-scan images is generated by multiplying the spectrum of each individual A-scan of the first training full spectrum (HR) B-scan image with a Gaussian window having a particular center position or bandwidth.

31. The system according to claim 30, wherein in (i) the number of training sub-band (LR) B-scan images is a plurality of training sub-band (LR) B-scan images, wherein each of the plurality of training sub-band (LR) B-scan images is generated with a different Gaussian window having a different particular center position or bandwidth that is unique to the training sub-band (LR) B-scan image.

32. The system according to claim 30, wherein in (i) the number of training sub-band (LR) B-scan images is a plurality of training sub-band (LR) B-scan images and wherein the plurality of training sub-band (LR) B-scan images are input into the neural network in separate iterations.

33. The system according to claim 25, wherein in (ii) the calculating the loss value includes computing the L2 norm between the predicted neural network output and the second training full spectrum (HR) B-scan image, and wherein the optimizing comprises adjusting the one or more parameters of the neural network based on the L2 norm.

34. The system according to claim 25, wherein in (ii) the optimizing comprises optimizing the one or more parameters of the neural network based on the calculated loss value using an optimizer.

35. The system according to claim 34, wherein the optimizer is the Adam optimizer.

36. The system according to claim 25, wherein the neural network is a convolutional neural network, a transformer-based neural network, or another deep learning architecture suitable for image processing tasks.

37. The system according to claim 36, wherein the neural network is a convolutional neural network that comprises a U-net architecture.

38. The system according to claim 25, wherein in (ii) the providing, calculating and optimizing steps are repeated a predetermined number of times or until predetermined convergence criterion or criteria are satisfied.
